(19) United States
(12) Patent Application Publication
(10) Pub. No.: US 2018/0045937 A1
(43) Pub. Date: Feb. 15, 2018

(54) AUTOMATED 3-D MEASUREMENT

(71) Applicant: Zeta Instruments, Inc., San Jose, CA (US)

(72) Inventors: James Jianguo Xu, San Jose, CA (US); Ronny Soetarman, Fremont, CA (US)

(21) Appl. No.: 15/233,812

(22) Filed: Aug. 10, 2016

(51) Int. Cl. G02B 21/00; G06T 7/00

(52) U.S. Cl. CPC G02B 21/0028; G06T 7/0004; G02B 21/008; G06T 2207/10056; G06T 2207/30148

(57) ABSTRACT

A method of generating 3D information of a sample using an optical microscope includes: varying the distance between the sample and an objective lens of the optical microscope at predetermined steps, capturing an image at each predetermined step. In one example, the method further includes: determining a characteristic of each pixel in each captured image; determining, for each captured image, the greatest characteristic across all pixels in the captured image; and comparing the greatest characteristic for each captured image to determine if a surface of the sample is present at each step. In another example, the method further includes: determining a characteristic of each pixel in each captured image; determining, for each captured image, a count of pixels that have a characteristic value within a first range; and determining if a surface of the sample is present at each step based on the count of pixels for each captured image.

### TECHNICAL FIELD

The described embodiments relate generally to measuring 3-D information of a sample and more particularly to automatically measuring 3-D information in a fast and reliable fashion.

### BACKGROUND INFORMATION

Three-dimensional (3-D) measurement of various objects or samples is useful in many different applications. One such application is during wafer level package processing. 3-D measurement information of a wafer during different steps of wafer level fabrication can provide insight as to the presence of wafer processing defects that may be present on the wafer. 3-D measurement information of the wafer during wafer level fabrication can provide insight as to the absence of defects before additional capital is expended to continue processing the wafer. 3-D measurement information of a sample is currently gathered by human manipulation of a microscope. The human user focuses the microscope using their eyes to determine when the microscope is focused on a surface of the sample. An improved method of gathering 3-D measurement information is needed.

### SUMMARY

In a first novel aspect, three-dimensional (3-D) information of a sample is generated using an optical microscope that varies the distance between the sample and an objective lens of the optical microscope at pre-determined steps. The optical microscope captures an image at each pre-determined step and determines a characteristic of each pixel in each captured image. For each captured image, the greatest characteristic across all pixels in the captured image is determined. The greatest characteristic for each captured image is compared to determine if a surface of the sample is present at each pre-determined step.

In a first example, the characteristic of each pixel includes intensity, contrast, or fringe contrast.

In a second example, the optical microscope includes a stage that is configured to support a sample and the optical microscope is adapted to communicate with a computer system that includes a memory device that is adapted to store each captured image.

In a third example, the optical microscope is a confocal microscope, a structured illumination microscope, or an interferometer microscope.

In a second novel aspect, three-dimensional (3-D) information of a sample is generated using an optical microscope that varies the distance between the sample and an objective lens of the optical microscope at pre-determined steps and captures an image at each pre-determined step. A characteristic of each pixel in each captured image is determined. For each captured image, a count of pixels that have a characteristic value within a first range is determined. The presence of a surface of the sample at each pre-determined step is determined based on the count of pixels for each captured image.

In a first example, the characteristic of each pixel includes intensity, contrast, or fringe contrast.

In a second example, the optical microscope includes a stage that is configured to support a sample and the optical microscope is adapted to communicate with a computer system that includes a memory device that is adapted to store each captured image.

In a third example, the optical microscope is a confocal microscope, a structured illumination microscope, or an interferometer microscope.

Further details and embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a diagram of a semi-automated 3-D metrology system 1 that performs automated 3-D measurement of a sample.

FIG. 2 is a diagram of a 3-D imaging microscope 10 including adjustable objective lenses 11 and an adjustable stage 12.

FIG. 3 is a diagram of a 3-D metrology system 20 including a 3-D microscope, a sample handler, a computer, a display, and input devices.

FIG. 4 is a diagram illustrating a method of capturing images as the distance between the objective lens of the optical microscope and the stage is varied.

FIG. 5 is a chart illustrating the distance between the objective lens of the optical microscope and the stage for which each x-y coordinate had the maximum characteristic value.

FIG. 6 is a 3-D diagram of an image rendered using the maximum characteristic value for each x-y coordinate shown in FIG. 5.

FIG. 7 is a diagram illustrating peak mode operation using images captured at various distances.

FIG. 8 is a diagram illustrating peak mode operation using images captured at various distances when a via is within the field of view of the optical microscope.

FIG. 9 is a chart illustrating the 3-D information resulting from the peak mode operation.

FIG. 10 is a diagram illustrating summation mode operation using images captured at various distances.

FIG. 11 is a diagram illustrating erroneous surface detection when using summation mode operation.

FIG. 12 is a chart illustrating the 3-D information resulting from the summation mode operation.

FIG. 13 is a diagram illustrating range mode operation using images captured at various distances.

FIG. 14 is a chart illustrating the 3-D information resulting from the range mode operation.

FIG. 15 is a chart illustrating only the count of pixels that have a characteristic value within a first range.

FIG. 16 is a chart illustrating only the count of pixels that have a characteristic value within a second range.

FIG. 17 is a flowchart illustrating the various steps included in peak mode operation.

FIG. 18 is a flowchart illustrating the various steps included in range mode operation.

### DETAILED DESCRIPTION

Reference will now be made in detail to background examples and some embodiments of the invention, examples of which are illustrated in the accompanying drawings. In the description and claims below, relational terms such as “top”, “down”, “upper”, “lower”, “top”, “bottom”, “left” and “right” may be used to describe relative orientations between different parts of a structure being described, and it is to be understood that the overall structure being described can actually be oriented in any way in three-dimensional space.

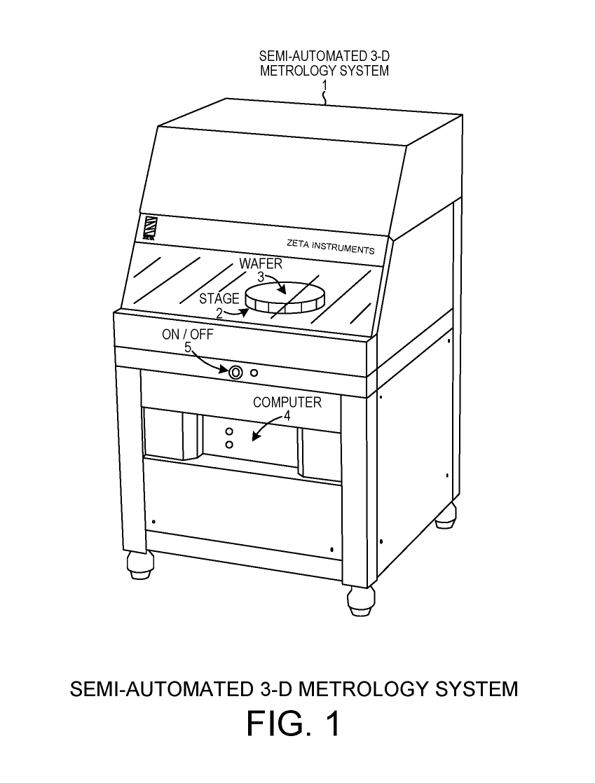

FIG. 1 is a diagram of a semi-automated 3-D metrology system 1. Semi-automated 3-D metrology system 1 includes an optical microscope (not shown), an ON/OFF button 5, a computer 4 and a stage 2. In operation, a wafer 3 is placed on the stage 2. The function of the semi-automated 3-D metrology system 1 is to capture multiple images of an object and generate 3-D information describing various surfaces of the object automatically. This is also referred to as a “scan” of an object. Wafer 3 is an example of an object that is analyzed by the semi-automated 3-D metrology system 1. An object may also be referred to as a sample. In operation, the wafer 3 is placed on stage 2 and the semi-automated 3-D metrology system 1 begins the process of automatically generating 3-D information describing the surfaces of the wafer 3. In one example, the semi-automated 3-D metrology system 1 is started by pressing a designated key on a keyboard (not shown) that is connected to computer 4. In another example, the automated 3-D metrology system 1 is started by sending a start command to the computer 4 across a network (not shown). Automated 3-D metrology system 1 may also be configured to mate with an automated wafer handling system (not shown) that automatically removes a wafer once a scan of the wafer is completed and inserts a new wafer for scanning.

A fully automated 3-D metrology system (not shown) is similar to the semi-automated 3-D metrology system of FIG. 1; however, a fully automated 3-D metrology system also includes a robotic handler that can automatically pick up a wafer and place the wafer onto the stage without human intervention. In a similar fashion, a fully automated 3-D metrology system can also use the robotic handler to automatically pickup a wafer from the stage and remove the wafer from the stage. A fully automated 3-D metrology system is desirable during the production of many wafers because it avoids possible contamination by a human operator and improves time efficiency and overall cost. Alternatively, the semi-automated 3-D metrology system 1 is desirable during research and development activities when only a small number of wafers need to be measured.

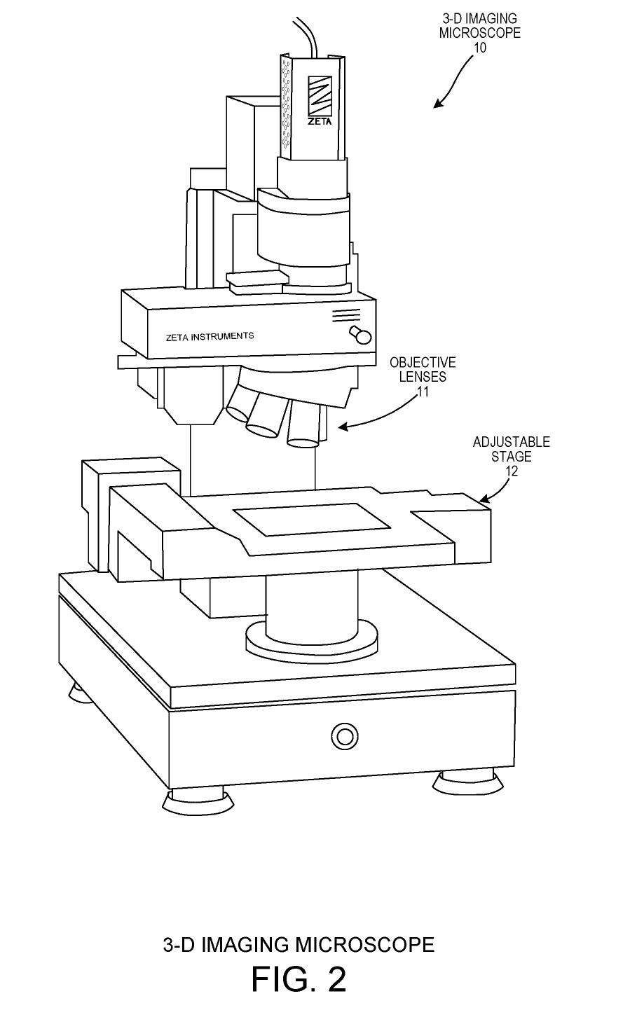

FIG. 2 is a diagram of a 3-D imaging microscope 10 including multiple objective lenses 11 and an adjustable stage 12. 3-D imaging microscope may be a confocal microscope, a structured illumination microscope, an interferometer microscope or any other type of microscope well known in the art. A confocal microscope will measure intensity. A structured illumination microscope will measure contrast of a projected structure. An interferometer microscope will measure interference fringe contrast.

In operation, a wafer is placed on adjustable stage 12 and an objective lens is selected. The 3-D imaging microscope 10 captures multiple images of the wafer as the height of the stage, on which the wafer rests, is adjusted. This results in multiple images of the wafer to be captured while the wafer is located at various distances away from the selected lens. In one alternate example, the wafer is placed on a fixed stage and the position of the objective lens is adjusted, thereby varying the distance between the objective lens and the sample without moving the stage. In another example, the stage is adjustable in the x-y direction and the objective lens is adjustable in the z-direction.

The captured images may be stored locally in a memory included in 3-D imaging microscope 10. Alternatively, the captured images may be stored in a data storage device included in a computer system, where the 3-D microscope 10 communicates the captured images to the computer system across a data communication link. Examples of a data communication link include: a Universal Serial Bus (USB) Interface, an ethernet connection, a FireWire bus interface, a wireless network such as WiFi.

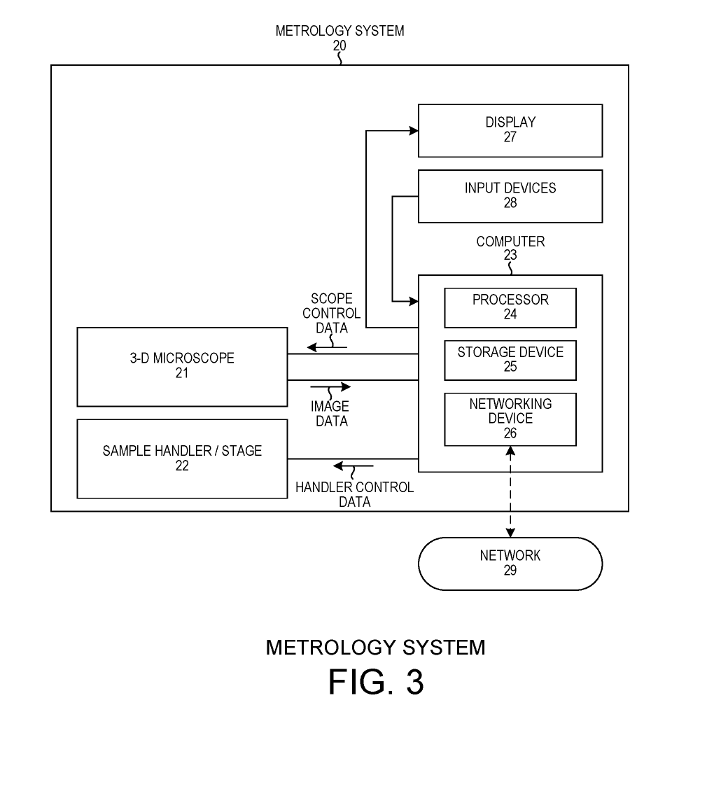

FIG. 3 is a diagram of a 3-D metrology system 20 including a 3-D microscope 21, a sample handler 22, a computer 23, a display 27 (optional), and input devices 28. 3-D metrology system 20 is an example of a system that is included in semi-automated 3-D metrology system 1. Computer 23 includes a processor 24, a storage device 25, and a network device 26 (optional). The computer outputs information to a user via display 27. The display 27 may be used as an input device as well if the display is a touch screen device. Input devices 28 may include a keyboard and a mouse. The computer 23 controls the operation of 3-D microscope 21 and sample handler/stage 22. When a start scan command is received by the computer 23, the computer sends one or more commands to configure the 3-D microscope for image capturing (“scope control data”). For example, the correct objective lens needs to be selected, the resolution of the images to be captured needs to be selected, and the mode of storing captured images needs to be selected. When a start scan command is received by the computer 23, the computer sends one or more commands to configure the sample handler/stage 22 (“handler control data”). For example, the correct height (z-direction) adjustment needs to be selected and the correct horizontal (x-y dimension) alignment needs to be selected.

During operation, the computer 23 causes sample handler/stage 22 to be adjusted to the proper position. Once the sample handler/stage 22 is properly positioned, the computer 23 will cause the 3-D microscope to focus on a focal plane and capture at least one image. The computer 23 will then cause that stage to be move in the z-direction such that the distance between the sample and the objective lens of the optical microscope is changed. Once the stage is moved to the new position, the computer 23 will cause the optical microscope to capture a second image. This process continues until an image is captured at each desired distance between the objective lens of the optical microscope and the sample. The images captured at each distance are communicated from 3-D microscope 21 to computer 23 (“image data”). The captured images are stored in storage device 25 included in computer 23. In one example, the computer 23 analyzes the captured images and outputs 3-D information to display 27. In another example, computer 23 analyzes the captured images and outputs 3-D information to a remote device via network 29. In yet another example, computer 23 does not analyze the captured images, but rather sends the captured images to another device via network 29 for processing. 3-D information may include a 3-D image rendered based on the captured images. 3-D information may not include any images, but rather include data based on various characteristics of each captured image.

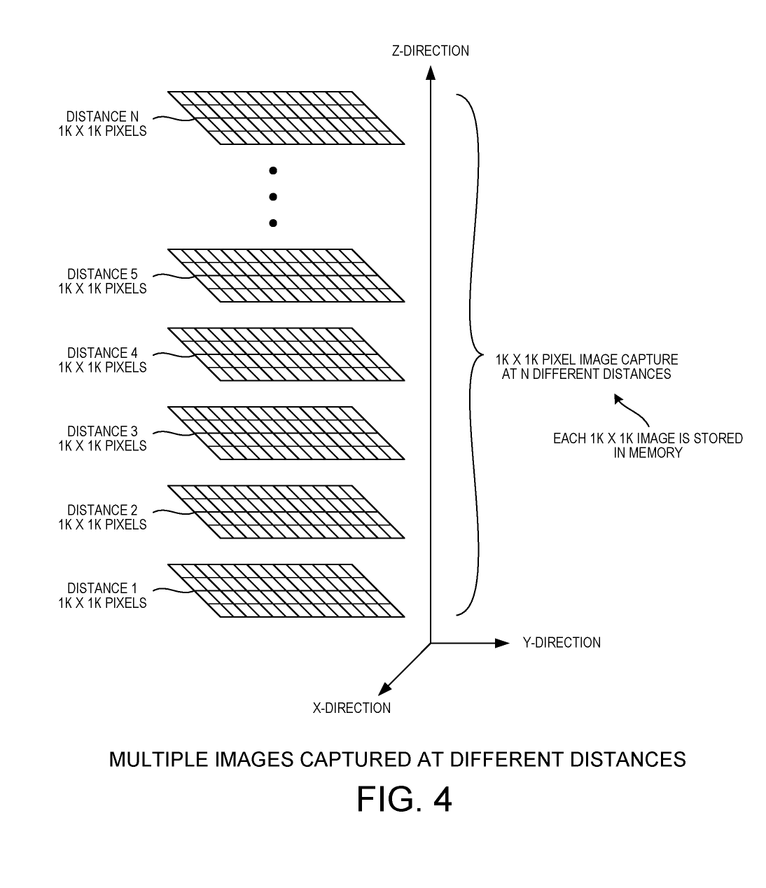

FIG. 4 is a diagram illustrating a method of capturing images as the distance between the objective lens of the optical microscope and the sample is varied. In the embodiment illustrated in FIG. 4, each image includes one-thousand by one-thousand pixels. In other embodiments, the image may include various configurations of pixels. In one example, the spacing between consecutive distances is fixed to be a predetermined amount. In another example, the spacing between consecutive distances may not be fixed. This no fixed spacing between images in the z-direction may be advantageous in the event that additional z-direction resolution is required for only a portion of the z-direction scan of the sample. The z-direction resolution is based on the number of images captured per unit length in the z-direction, therefore capturing additional image images per unit length in the z-direction will increase the z-direction resolution measured. Conversely, capturing fewer images per unit length in the z-direction will decrease the z-direction resolution measured.

As discussed above, the optical microscope is first adjusted to be focused on a focal plane located at distance 1 away from an objective lens of the optical microscope. The optical microscope then captures an image that is stored in a storage device (i.e. “memory”). The stage is then adjusted to such that the distance between the objective lens of the optical microscope and the sample is distance 2. The optical microscope then captures an image that is stored in the storage device. The stage is then adjusted to such that the distance between the objective lens of the optical microscope and the sample is distance 3. The optical microscope then captures an image that is stored in the storage device. The stage is then adjusted to such that the distance between the objective lens of the optical microscope and the sample is distance 4. The optical microscope then captures an image that is stored in the storage device. The stage is then adjusted to such that the distance between the objective lens of the optical microscope and the sample is distance 5. The optical microscope then captures an image that is stored in the storage device. The process is continued for N different distances between the objective lens of the optical microscope and the sample. Information indicating which image is associated with each distance is also stored in the storage device for later processing.

In an alternative embodiment, the distance between the objective lens of the optical microscope and the sample is fixed. Rather, the optical microscope includes a zoom lens that allows the optical microscope to vary the focal plane of the optical microscope. In this fashion, the focal plane of the optical microscope is varied across N different focal planes while the stage, and the sample supported by the stage, is stationary. An image is captured for each focal plane and stored in a storage device. The captured images across all the various focal planes are then processed to determine 3-D information of the sample. This embodiment requires a zoom lens that can provide sufficient resolution across all focal planes and that introduces minimal image distortion. Additionally, calibration between each zoom position and resulting focal length of the zoom lens is required.

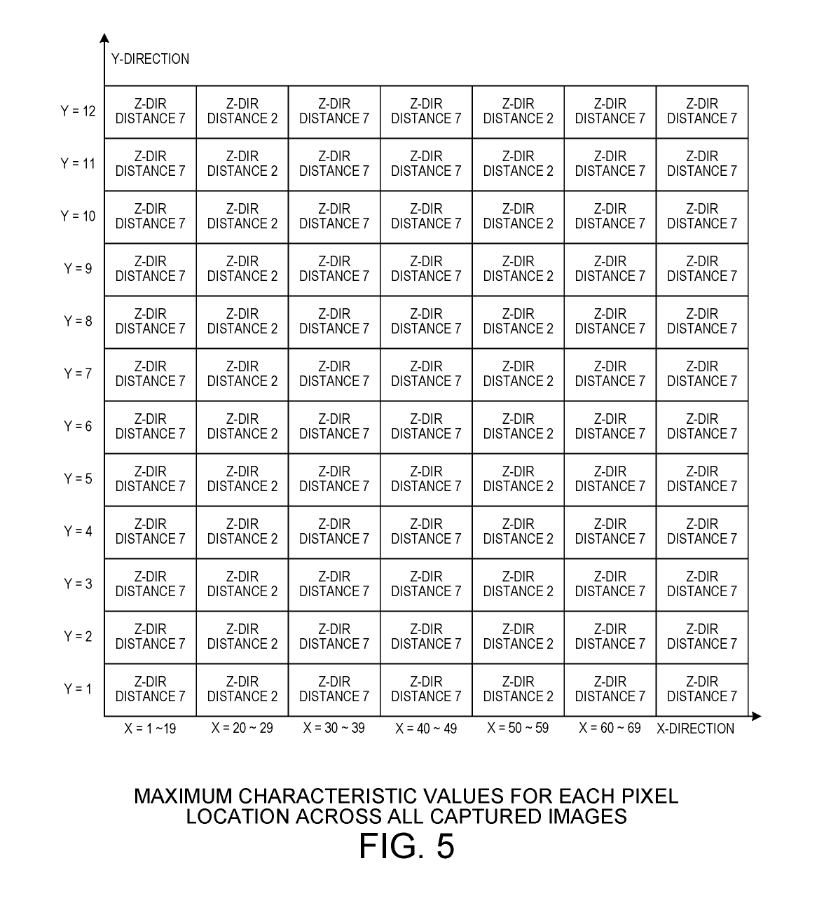

FIG. 5 is a chart illustrating the distance between the objective lens of the optical microscope and the sample for which each x-y coordinate had the maximum characteristic value. Once images are captured and stored for each distance, characteristics of each pixel of each image can be analyzed. For example, the intensity of the light of each pixel of each image can be analyzed. In another example, the contrast of each pixel of each image can be analyzed. In yet another example, the fringe contrast of each pixel of each image can be analyzed. The contrast of a pixel may be determined by comparing the intensity of a pixel with that of a preset number of surrounding pixels. For additional description regarding how to generate contrast information, see U.S. patent application Ser. No. 12/699,824, entitled “3-D Optical Microscope”, filed Feb. 3, 2010, by James Jianguo Xu et al. (the subject matter of which is incorporated herein by reference).

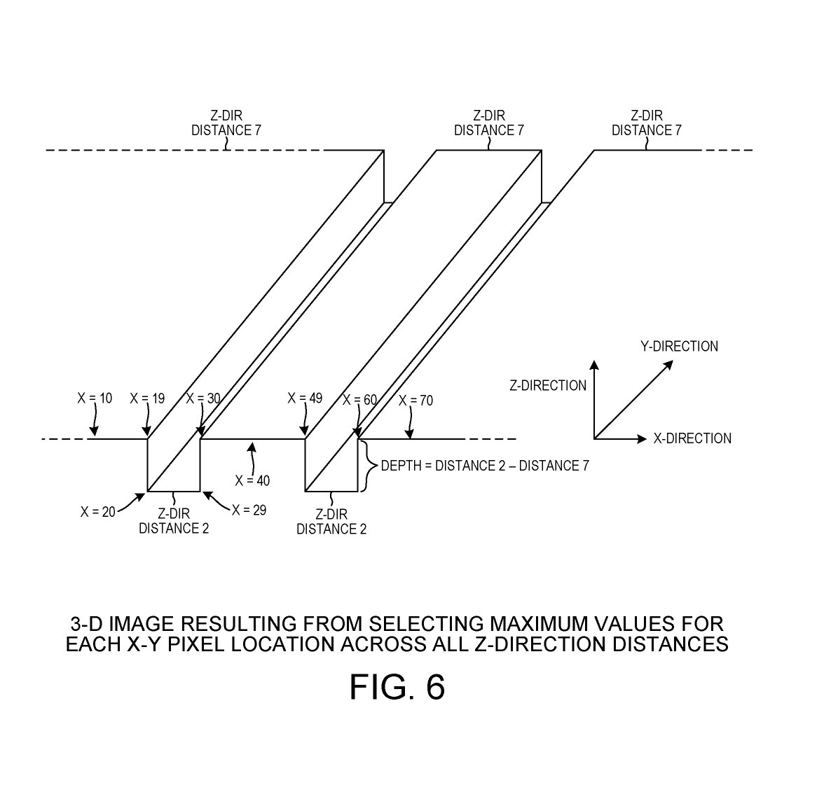

FIG. 6 is a 3-D diagram of a 3-D image rendered using the maximum characteristic value for each x-y coordinate shown in FIG. 5. All pixels with an X location between 1 and 19 have a maximum characteristic value at z-direction distance 7. All pixels with and X location between 20 and 29 have a maximum characteristic value at z-direction distance 2. All pixels with and X location between 30 and 49 have a maximum characteristic value at z-direction distance 7. All pixels with and X location between 50 and 59 have a maximum characteristic value at z-direction distance 2. All pixels with and X location between 60 and 79 have a maximum characteristic value at z-direction distance 7. In this fashion, the 3-D image illustrated in FIG. 6 can be created using the maximum characteristic value per x-y pixel across all captured images. Additionally, given that distance 2 is known and that distance 7 is known, the depth of the well illustrated in FIG. 6 can be calculated by subtracting distance 7 from distance 2.

Peak Mode Operation

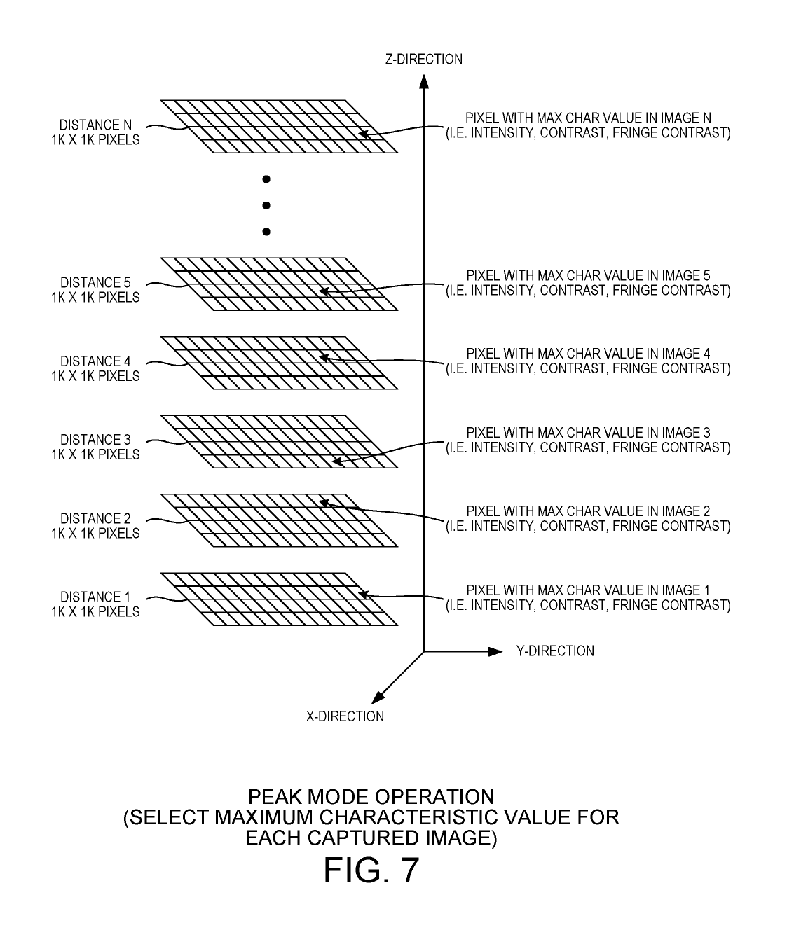

FIG. 7 is a diagram illustrating peak mode operation using images captured at various distances. As discussed regarding FIG. 4 above, the optical microscope is first adjusted to be focused on a plane located at distance 1 away from an objective lens of the optical microscope. The optical microscope then captures an image that is stored in a storage device (i.e. “memory”). The stage is then adjusted to such that the distance between the objective lens of the optical microscope and the sample is distance 2. The optical microscope then captures an image that is stored in the storage device. The stage is then adjusted to such that the distance between the objective lens of the optical microscope and the sample is distance 3. The optical microscope then captures an image that is stored in the storage device. The stage is then adjusted to such that the distance between the objective lens of the optical microscope and the sample is distance 4. The optical microscope then captures an image that is stored in the storage device. The stage is then adjusted to such that the distance between the objective lens of the optical microscope and the sample is distance 5. The optical microscope then captures an image that is stored in the storage device. The process is continued for N different distances between the objective lens of the optical microscope and the stage. Information indicating which image is associated with each distance is also stored in the storage device for later processing.

Instead of determining the maximum characteristic value for each x-y location across all captured images at various z-distances, the maximum characteristic value across all x-y locations in a single captured image at one z-distance is determined in peak mode operation. Said another way, for each captured image the maximum characteristic value across all pixels included in the captured image is selected. As illustrated in FIG. 7, the pixel location with the maximum characteristic value will likely vary between different captured images. The characteristic may be intensity, contrast, or fringe contrast.

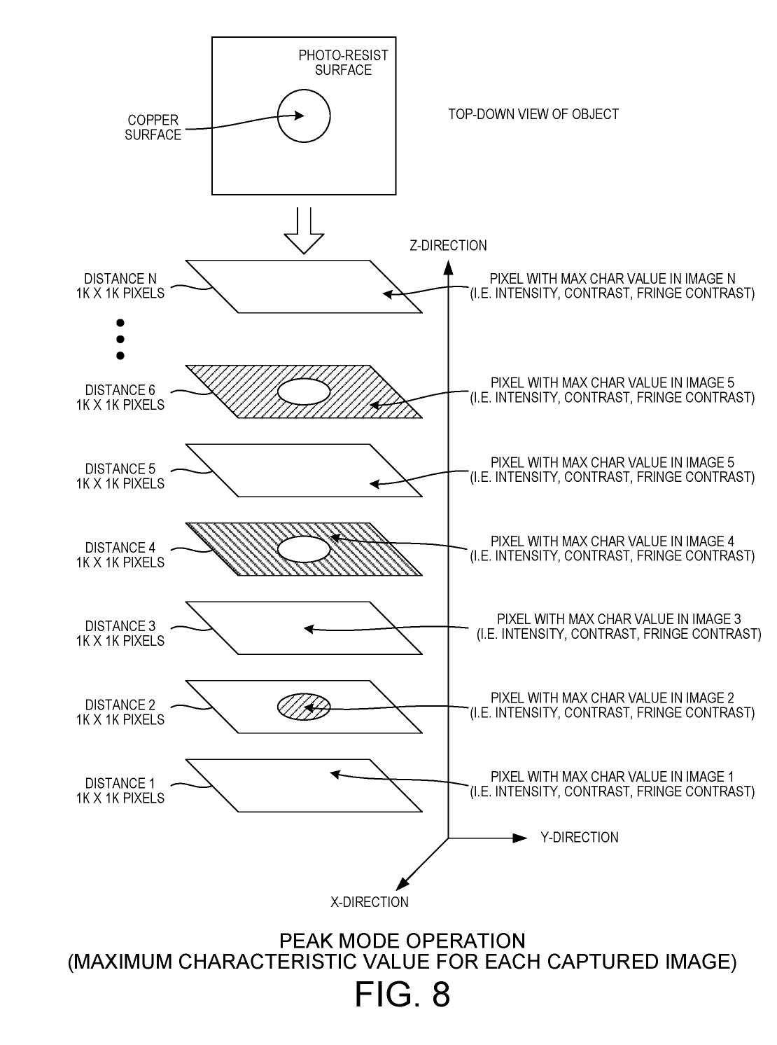

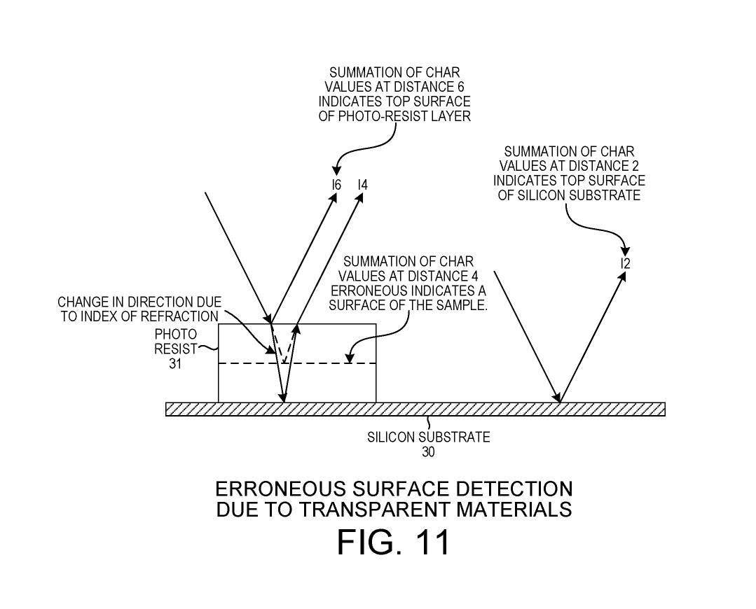

FIG. 8 is a diagram illustrating peak mode operation using images captured at various distances when a via is within the field of view of the optical microscope. A via is a vertical electrical connection passing completely through a layer of a wafer. The top-down view of the object shows the cross-section area of the via in the x-y plane. The via also has a depth of specific depth in the z-direction. The images captured at various distances are shown below. At distance 1, the optical microscope is not focused on the top surface of the wafer or the bottom surface of the via. At distance 2, the optical microscope is focused on the bottom surface of the via, but is not focused on the top surface of the wafer. This results in an increased characteristic value (intensity/contrast/fringe contrast) in the pixels that receive light reflecting from the bottom surface of the via compared to the pixels that receive reflected light from other surfaces that are out of focus (top surface of the wafer). At distance 3, the optical microscope is not focused on the top surface of the wafer or the bottom surface of the via. Therefore, at distance 3 the maximum characteristic value will be substantially lower than the maximum characteristic value measured at distance 2. At distance 4, the optical microscope is not focused on any surface of the sample; however, due to the difference of the index of refraction of air and the index of refraction of the photo-resist layer an increase in the maximum characteristic value (intensity/contrast/fringe contrast) is measured. FIG. 11 and the accompanying text describe this phenomenon in greater detail. At distance 6, optical microscope is focused on the top surface of the wafer, but is not focused on the bottom surface of the via. This results in an increased characteristic value (intensity/contrast/fringe contrast) in the pixel that receive light reflected from the top surface of the wafer compared to the pixels that receive reflected light from other surfaces that are out of focus (bottom surface of the via). Once the maximum characteristic value from each captured image is determined, the results can be utilized to determine at which distances a surface of the wafer is located.

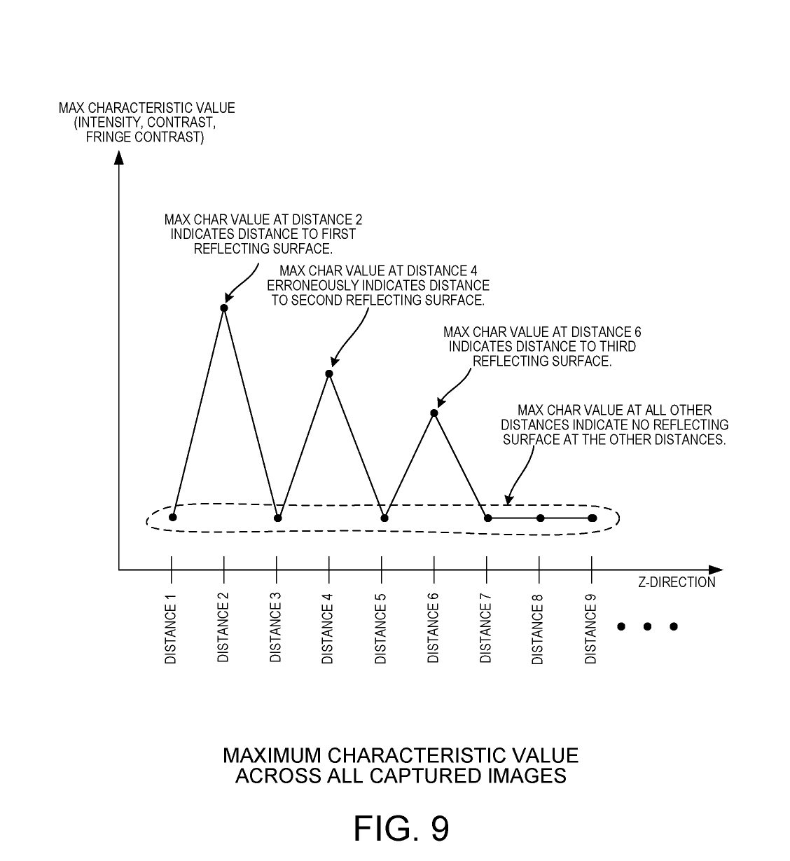

FIG. 9 is a chart illustrating the 3-D information resulting from the peak mode operation. As discussed regarding FIG. 8, the maximum characteristic value of the images captured at distances 1, 3 and 5 have a lower maximum characteristic value compared to the maximum characteristic value of the images captured at distances 2, 4 and 6. The curve of the maximum characteristics values at various z-distances may contain noise due to environmental effects, such as vibration. To minimize such noise, a standard smoothing method, such as Gaussian filtering with certain kernel size, can be applied before further data analysis.

One method of comparing the maximum characteristics values is performed by a peak finding algorithm. In one example, a derivative method is used to locate zero crossing point along the z-axis to determine the distance at which each “peak” is present. The maximum characteristic value at each distance where a peak is found is then compared to determine the distance where the greatest characteristic value was measured. In the case of FIG. 9, a peak will be found at distance 2, which is used as an indication that a surface of the wafer is located at distance 2.

Another method of comparing the maximum characteristics values is performed by comparing each maximum characteristic value with a preset threshold value. The threshold value may be calculated based on the wafer materials, distances, and the specification of the optical microscope. Alternatively, the threshold value may be determined by empirical testing before automated processing. In either case, the maximum characteristic value for each captured image is compared to the threshold value. If the maximum characteristic value is greater than the threshold, then it is determined that the maximum characteristic value indicates the presence of a surface of the wafer. If the maximum characteristic value is not greater than the threshold, then it is determined that the maximum characteristic value does not indicate a surface of the wafer.

Summation Mode Operation

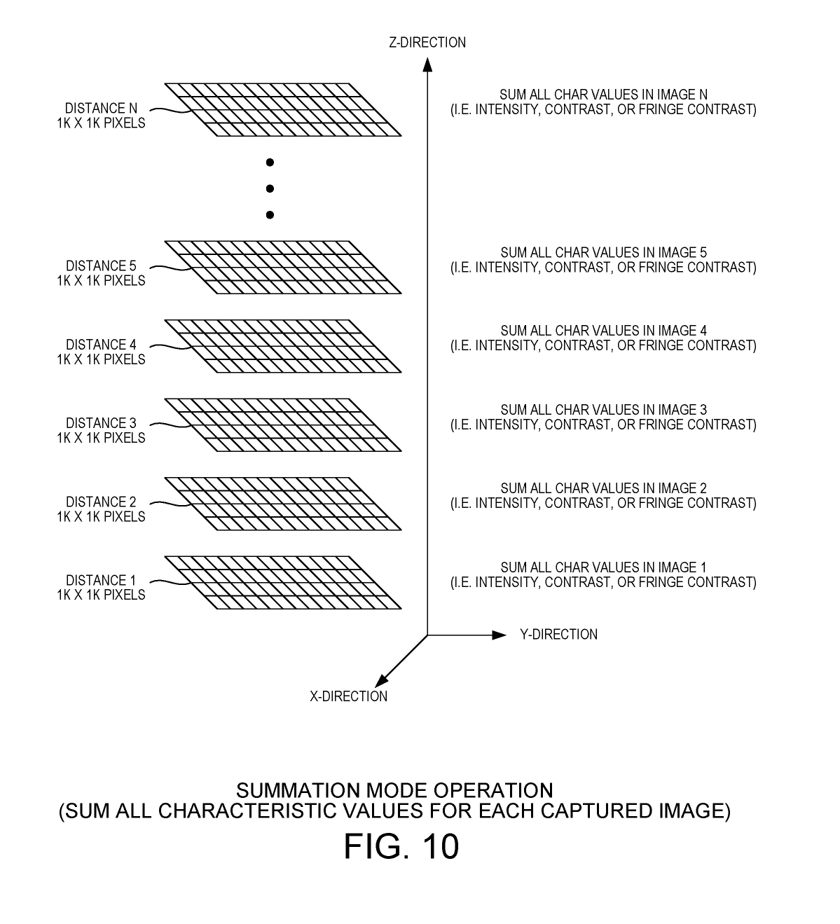

FIG. 10 is a diagram illustrating summation mode operation using images captured at various distances. As discussed regarding FIG. 4 above, the optical microscope is first adjusted to be focused on a plane located at distance 1 away from an objective lens of the optical microscope. The optical microscope then captures an image that is stored in a storage device (i.e. “memory”). The stage is then adjusted to such that the distance between the objective lens of the optical microscope and the sample is distance 2. The optical microscope then captures an image that is stored in the storage device. The stage is then adjusted to such that the distance between the objective lens of the optical microscope and the sample is distance 3. The optical microscope then captures an image that is stored in the storage device. The stage is then adjusted to such that the distance between the objective lens of the optical microscope and the sample is distance 4. The optical microscope then captures an image that is stored in the storage device. The stage is then adjusted to such that the distance between the objective lens of the optical microscope and the sample is distance 5. The optical microscope then captures an image that is stored in the storage device. The process is continued for N different distances between the objective lens of the optical microscope and the sample. Information indicating which image is associated with each distance is also stored in the storage device for later processing.

Instead of determining the maximum characteristic value across all x-y locations in a single captured image at one z-distance, the characteristic values of all x-y locations of each captured image are added together. Said another way, for each captured image the characteristic values for all pixels included in the captured image are summed together. The characteristic may be intensity, contrast, or fringe contrast. A summed characteristics value that is substantially greater than the average summed characteristic value of neighboring z-distances indicates that a surface of the wafer is present at the distance. However, this method can also result in false positives as described in FIG. 11.

FIG. 11 is a diagram illustrating erroneous surface detection when using summation mode operation. The wafer illustrated in FIG. 11 includes a silicon substrate 30 and a photo-resist layer 31 deposited on top of the silicon substrate 30. The top surface of the silicon substrate 30 is located at distance 2. The top surface of the photo-resist layer 31 is located at distance 6. The image captured at distance 2 will result in a summation of characteristic values that is substantially greater than other images captured at distances where a surface of the wafer is not present. The image captured at distance 6 will result in a summation of characteristic values that is substantially greater than other images captured at distances where a surface of the wafer is not present. At this point, the summation mode operation seems to be a valid indicator of the presence of a surface of the wafer. However, the image captured at distance 4 will result in a summation of characteristic values that is substantially greater than other images captured at distances where a surface of the wafer is not present. This is a problem, because as is clearly shown in FIG. 11, a surface of the wafer is not located at distance 4. Rather, the increase in the summation of characteristics values at distance 4 is an artifact of the surfaces located at distances 2 and 6. A major portion of the light that irradiates the photo-resist layer does not reflect, but rather travels into the photo-resist layer. The angle at which this light travels is changed due to the difference of the index of refraction of air and photo-resist. The new angle is closer to normal than the angle of the light irradiating the top surface of the photo-resist. The light travels to the top surface of the silicon substrate beneath the photo-resist layer. The light is then reflected by the highly reflected silicon substrate layer. Than angle of the reflected light is changed again as the reflected light leaves the photo-resist layer and enters the air due to the difference in the index of refraction between air and the photo-resist layer. This redirect, reflecting, and again redirecting of the irradiating light causes the optical microscope to observe an increase in characteristic values (intensity/contrast/fringe contrast) at distance 4. This example illustrates that whenever a sample includes a transparent material, the summation mode operation will detect surfaces that are not present on the sample.

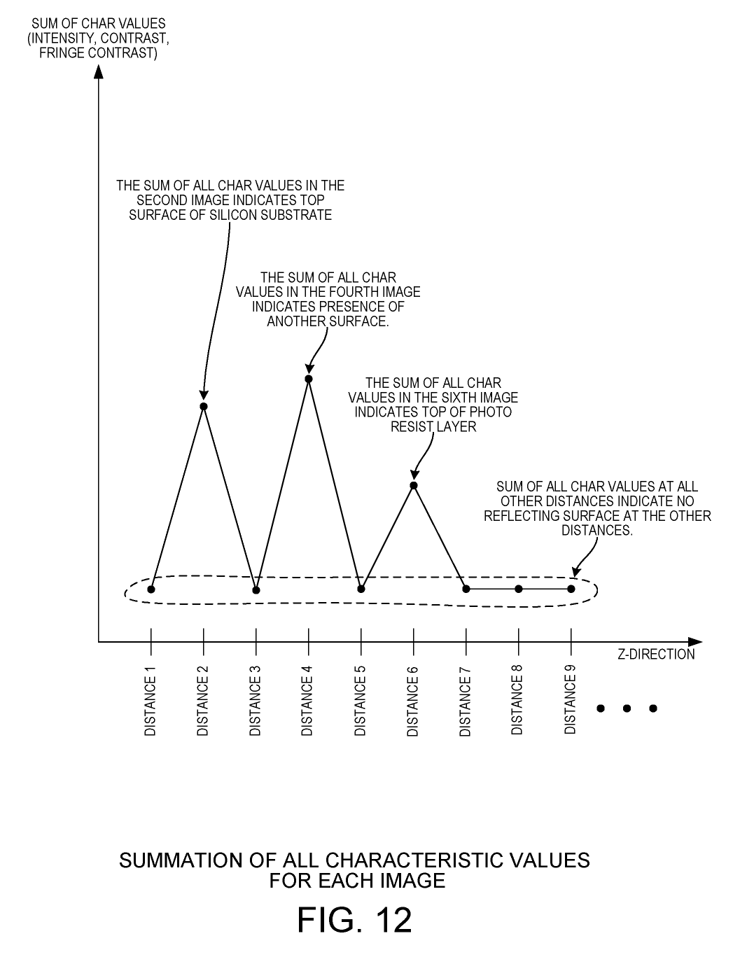

FIG. 12 is a chart illustrating the 3-D information resulting from the summation mode operation. This chart illustrates the result of the phenomenon illustrated in FIG. 11. The large value of summed characteristic values at distance 4 erroneously indicates the present of a surface at distance 4. A method that does not result in false positive indications of the presence of surface of the wafer is needed.

Range Mode Operation

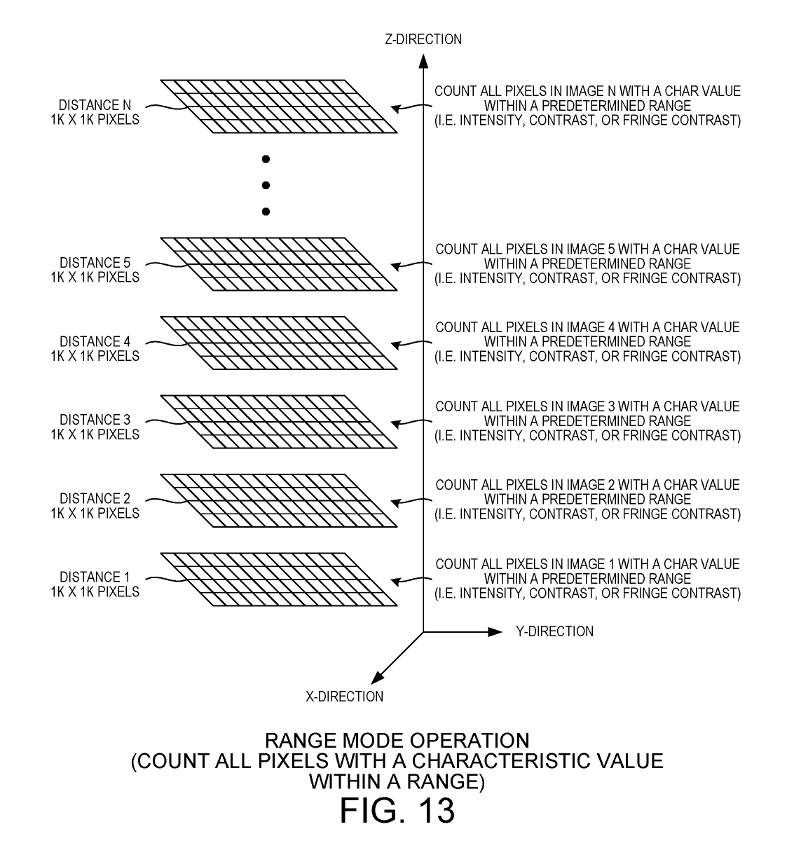

FIG. 13 is a diagram illustrating range mode operation using images captured at various distances. As discussed regarding FIG. 4 above, the optical microscope is first adjusted to be focused on a plane located at distance 1 away from an objective lens of the optical microscope. The optical microscope then captures an image that is stored in a storage device (i.e. “memory”). The stage is then adjusted to such that the distance between the objective lens of the optical microscope and the sample is distance 2. The optical microscope then captures an image that is stored in the storage device. The stage is then adjusted to such that the distance between the objective lens of the optical microscope and the sample is distance 3. The optical microscope then captures an image that is stored in the storage device. The stage is then adjusted to such that the distance between the objective lens of the optical microscope and the sample is distance 4. The optical microscope then captures an image that is stored in the storage device. The stage is then adjusted such that the distance between the objective lens of the optical microscope and the sample is distance 5. The optical microscope then captures an image that is stored in the storage device. The process is continued for N different distances between the objective lens of the optical microscope and the sample. Information indicating which image is associated with each distance is also stored in the storage device for later processing.

Instead of determining the summation of all characteristic values across all x-y locations in a single captured image at one z-distance, a count of pixels that have a characteristic value within a specific range that are included in the single captured image is determined. Said another way, for each captured image a count of pixels that have a characteristic value within a specific range is determined. The characteristic may be intensity, contrast, or fringe contrast. A count of pixels at one particular z-distance that is substantially greater than the average count of pixels at neighboring z-distances indicates that a surface of the wafer is present at the distance. This method reduces the false positives described in FIG. 11.

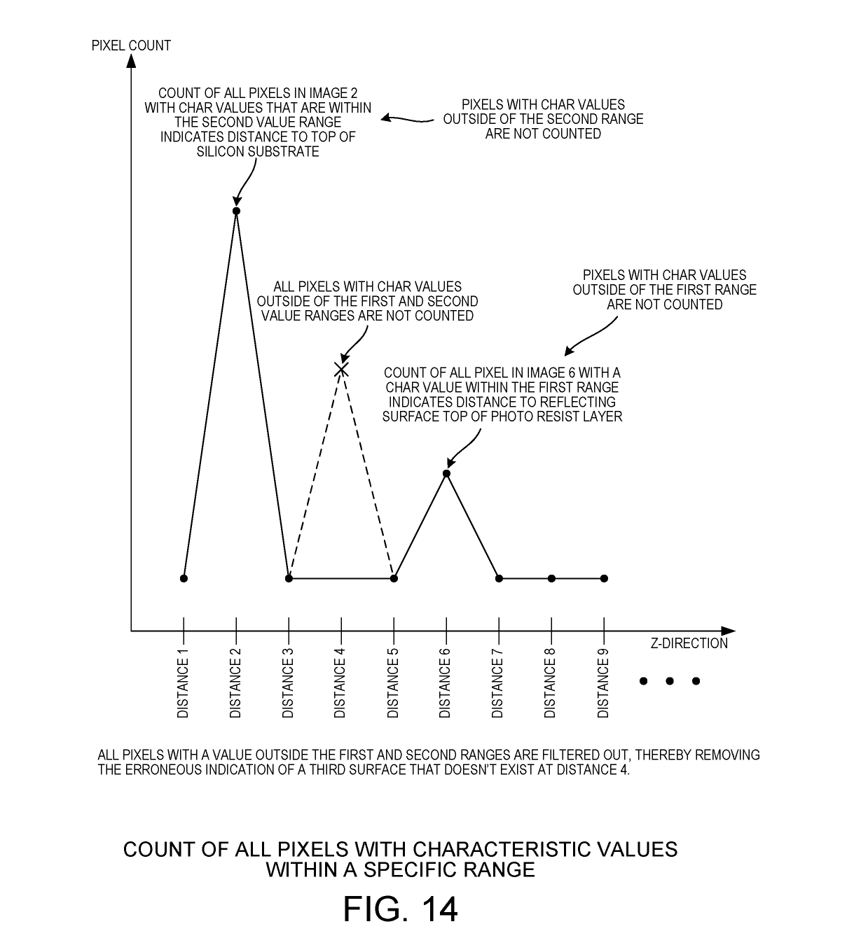

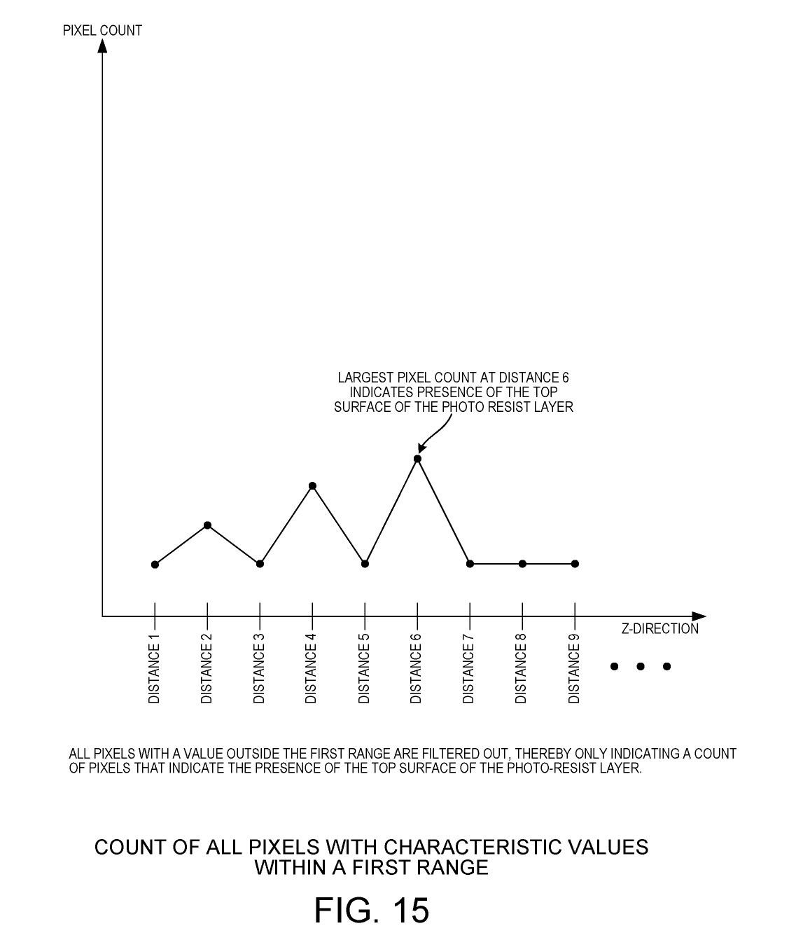

FIG. 14 is a chart illustrating the 3-D information resulting from the range mode operation. Given knowledge of the different types of material that are present on the wafer and the optical microscope configuration, an expected range of characteristic values can be determined for each material type. For example, photo-resist layer will reflect a relative small amount of light that irradiates the top surface of the photo-resist layer (i.e. 4%). Silicon layer will reflect light that irradiates the top surface of the silicon layer (i.e. 37%). The redirected reflections observed at distance 4 (i.e. 21%) will be substantially greater than the reflections observed at distance 6 from the top surface of the photo-resist layer; however, the redirected reflections observed at distance 4 (i.e. 21%) will be substantially less than the reflection observed at distance 2 from the top surface of the silicon substrate. Therefore, when looking for the top surface of the photo-resist layer, a first range that is centered on the expected characteristic value for photo-resist can be used to filter out pixels that have characteristic values outside of the first range, thereby filtering out pixels that have characteristic values not resulting from reflections from the top surface of the photo-resist layer. The pixel count across all distances generated by applying the first range of characteristic values is illustrated in FIG. 15. As shown in FIG. 15, some but not necessarily all pixels from other distances (surfaces) are filtered out by applying the first range. This occurs when the characteristic values measured at multiple distances fall within the first range. Nevertheless, application of the first range before counting pixels still functions to make the pixel count at the desired surface more prominent in comparison to other pixel counts at other distances. This is illustrated in FIG. 15. The pixel count at distance 6 is greater than the pixel count at distances 2 and 4 after the first range is applied, whereas before the first range was applied the pixel count at distance 6 was less than the pixel count at distances 2 and 4 (as shown in FIG. 14).

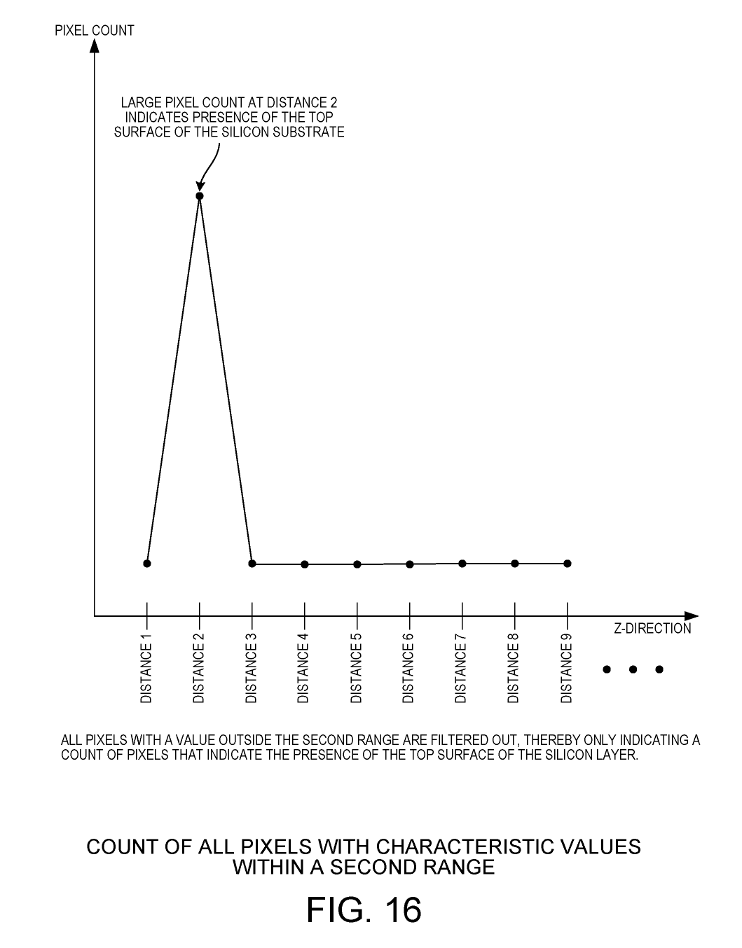

In a similar fashion, when looking for the top surface of the silicon substrate layer, a second range that is centered on the expected characteristic value for silicon substrate layer can be used to filter out pixels that have characteristic values outside of the second range, thereby filtering out pixels that have characteristic values not resulting from reflections from the top surface of the silicon substrate layer. The pixel count across all distances generated by applying the second range of characteristic values is illustrated in FIG. 16. This application of ranges reduces the false indication of a wafer surface located at distance 4 by virtue of the knowledge of what characteristic values are expected from all the material present on the wafer being scanned. As discussed regarding in FIG. 15, some but not necessarily all pixels from other distances (surfaces) are filtered out by applying a range. However, when the characteristic values measured at multiple distances do not fall within the same range, then the result of applying the range will eliminate all pixel counts from other distances (surfaces). FIG. 16 illustrates this scenario. In FIG. 16, the second range is applied before generating the pixel count at each distance. The result of applying the second range is that only pixels at distance 2 are counted. This creates a very clear indication that surface of the silicon substrate is located at distance 2.

It is noted, that reduce the impact caused by potential noise such as environmental vibration, a standard smoothing operation such as Gaussian filtering can be applied to the total pixel count along the z-distances before carrying out any peak searching operations.

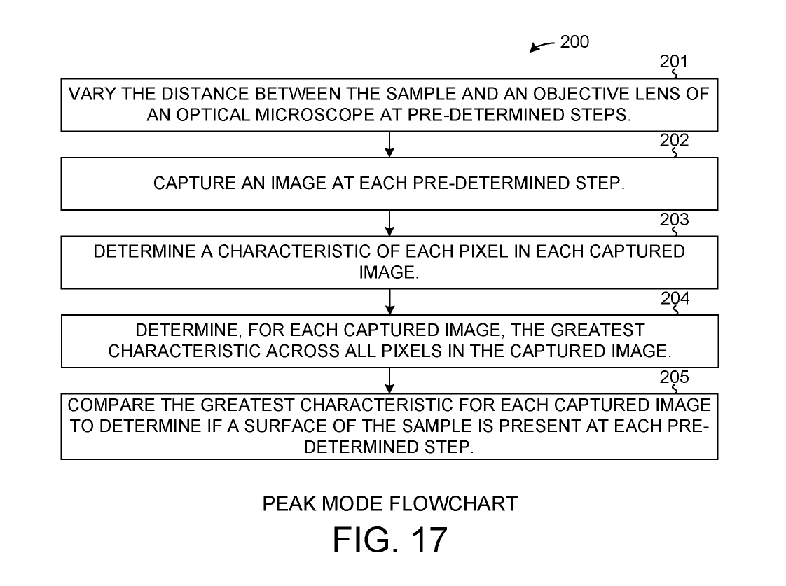

FIG. 17 is a flowchart 200 illustrating the various steps included in peak mode operation. In step 201, the distance between the sample and the objective lens of an optical microscope is varied at pre-determined steps. In step 202, an image is captured at each pre-determined step. In step 203, a characteristic of each pixel in each captured image is determined. In step 204, for each captured image, the greatest characteristic across all pixels in the captured image is determined. In step 205, the greatest characteristic for each captured image is compared to determine if a surface of the sample is present at each pre-determined step.

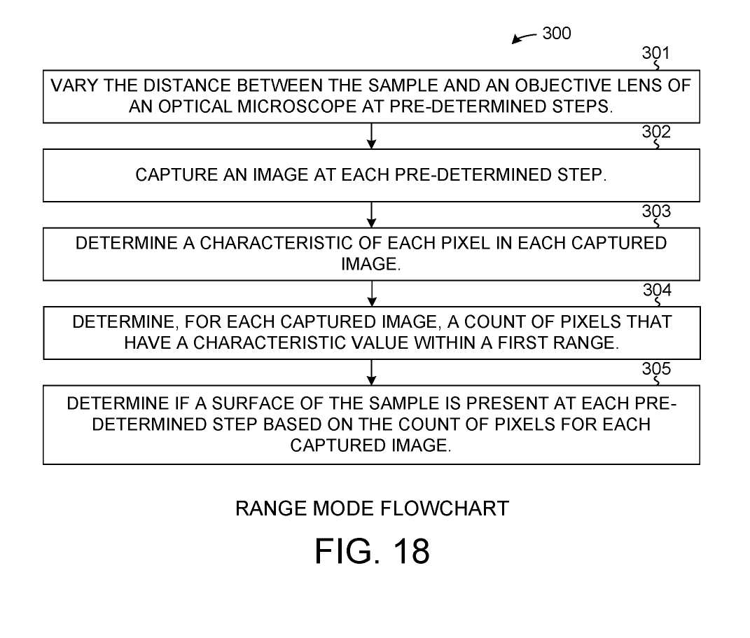

FIG. 18 is a flowchart 300 illustrating the various steps included in range mode operation. In step 301, the distance between the sample and the objective lens of an optical microscope is varied at pre-determined steps. In step 302, an image is captured at each pre-determined step. In step 303, a characteristic of each pixel in each captured image is determined. In step 304, for each captured image, a count of pixels that have a characteristic value within a first range is determined. In step 305, it is determined if a surface of the sample is present at each pre-determined step based on the count of pixels for each captured image.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A method of generating three-dimensional (3-D) information of a sample using an optical microscope, the method comprising:
varying the distance between the sample and an objective lens of the optical microscope at pre-determined steps;
capturing an image at each pre-determined step;
determining a characteristic of each pixel in each captured image;
determining, for each captured image, the greatest characteristic across all pixels in the captured image; and
comparing the greatest characteristic for each captured image to determine if a surface of the sample is present at each pre-determined step.

2. The method of claim 1, wherein the characteristic of each pixel is intensity.

3. The method of claim 1, wherein the characteristic of each pixel is contrast.

4. The method of claim 1, wherein the characteristic of each pixel is fringe contrast.

5. The method of claim 1, wherein the optical microscope includes a stage, wherein the sample is supported by the stage, wherein the optical microscope is adapted to communicate with a computer system, and wherein the computer system includes a memory device that is adapted to store each captured image.

6. The method of claim 1, wherein a 3-D image of the sample is created based on the pre-determined steps where it is determined that a surface of the sample is present.

7. The method of claim 1, wherein the optical microscope is a confocal microscope.

8. The method of claim 1, wherein the optical microscope is a structured illumination microscope.

9. The method of claim 1, wherein the optical microscope is an interferometer microscope.

10. A method of generating three-dimensional (3-D) information of a sample using an optical microscope, the method comprising:
varying the distance between the sample and an objective lens of the optical microscope at pre-determined steps;
capturing an image at each pre-determined step;
determining a characteristic of each pixel in each captured image;
determining, for each captured image, a count of pixels that have a characteristic value within a first range, wherein all pixels that do not have a characteristic value within the first range are not included in the count of pixels; and
determining if a surface of the sample is present at each pre-determined step based on the count of pixels for each captured image.

11. The method of claim 10, wherein the characteristic of each pixel is intensity.

12. The method of claim 10, wherein the characteristic of each pixel is contrast.

13. The method of claim 10, wherein the characteristic of each pixel is fringe contrast.

14. The method of claim 10, wherein the optical microscope includes a stage, wherein the sample is supported by the stage, wherein the optical microscope is adapted to communicate with a computer system, and wherein the computer system includes a memory device that is adapted to store each captured image.

15. The method of claim 10, wherein a 3-D image of the sample is created based on the pre-determined steps where it is determined that a surface of the sample is present.

16. The method of claim 10, wherein the optical microscope is a confocal microscope.

17. The method of claim 10, wherein the optical microscope is a structured illumination microscope.

18. The method of claim 10, wherein the optical microscope is an interferometer microscope.

19. A three-dimensional (3-D) measurement system, comprising:
a optical microscope comprising a objective lens and a stage, wherein the optical microscope is adapted to vary the distance between a sample supported by the stage and the objective lens of the optical microscope at pre-determined steps; and
a computer system comprising a processor and a storage device, wherein the computer system is adapted to:
store an image captured at each pre-determined step;
determine a characteristic of each pixel in each captured image;
determine, for each captured image, the greatest characteristic across all pixels in the captured image; and
compare the greatest characteristic for each captured image to determine if a surface of the sample is present at each pre-determined step.

20. A three-dimensional (3-D) measurement system, comprising:
a optical microscope comprising a objective lens and a stage, wherein the optical microscope is adapted to vary the distance between a sample supported by the stage and the objective lens of the optical microscope at pre-determined steps; and
a computer system comprising a processor and a storage device, wherein the computer system is adapted to:
store an image captured by the optical microscope at each pre-determined step;
determine a characteristic of each pixel in each captured image;
determine, for each captured image, a count of pixels that have a characteristic value within a first range, wherein all pixels that do not have a characteristic value within the first range are not included in the count of pixels; and
determine if a surface of the sample is present at each pre-determined step based on the count of pixels for each captured image.
